(19) United States
(12) Patent Application Publication
(10) Pub. No.: US 2007/0252050 A1
(43) Pub. Date: Nov. 1, 2007

(54) Hand positioner device for computer mouse

(76) Inventor: Robert D. Kennedy, Ottawa (CA)

Correspondence Address: NIXON PEABODY, LLP, 401 9TH STREET, NW, SUITE 900, WASHINGTON, DC, 20004-2128, US

(21) Appl. No.: 11/822,054

(22) Filed: Jul. 2, 2007

Related U.S. Application Data
(63) Continuation-in-part of application No. 11/183,883, filed on Jul. 19, 2005.
Application No. 11/183,883 is a continuation-in-part of application No. 10/845,090, filed on May 14, 2004.

(51) Int. Cl. B43L 15/00

(52) U.S. Cl. 248/118.3

(57) ABSTRACT

A device to be associated with a computer mouse, the device comprising a body which, when the device is in use, circumscribes and moves with the mouse when the mouse moves on a surface, the body provided with a support surface, the support surface being configured and adjustably positionable longitudinally so that when the device is in position with respect to the mouse, the support surface supports only a central portion of a heel of a user's hand at a height so that the user's hand and wrist are in an ergonomically correct, aligned position relative to each other during use of the mouse.

### RELATED APPLICATION

The present invention is a continuation-in-part of applicant's co-pending U.S. application Ser. No. 10/845,090, filed May 14, 2004, entitled HAND POSITIONER FOR COMPUTER MOUSE and Ser. No. 11/183,883, filed Jul. 19, 2005, entitled ADJUSTABLE HAND POSITIONER FOR COMPUTER MOUSE, the entire contents of which are incorporated herein by reference.

### FIELD OF THE INVENTION

The present invention relates to a device which is associated with a computer mouse to cause a user's hand and wrist to be in ergonomically correct positions relative to each other during use of the mouse.

### BACKGROUND OF THE INVENTION

A computer workstation that is not ergonomically suited to a user's shape, size and capabilities may hinder the user's performance. It is important that the user's posture, including hand and arm positioning with respect to the computer mouse, where a traditional mouse is used, is such to avoid awkward alignment of the hand and arm. Otherwise, repetitive motion injuries (RMI) may arise, affecting the user's muscles, and tissues connecting bones, such as tendons and ligaments. Inadequate computer workstation design may generate a fixed awkward wrist position, thus contributing to RMI.

One of the most publicized types of RMI is carpal tunnel syndrome (CTS), in which tendons, passing through a narrow tunnel in the wrists, become inflamed and put pressure on the median nerve of the hand. This causes a tingling sensation in the thumbs and adjacent fingers, and a burning sensation in the palms.

Ideally, an ergonomically correct position for a user at a computer workstation has the wrist of the hand controlling the mouse in a neutral position, with no bending, the hand being relaxed and in straight alignment with the associated forearm. In operation, there should be no bending of the user's wrist and fingers should fall naturally downward over the controls of the mouse. The user should be able to move the mouse with a full arm movement, keeping the wrist straight and in line with his or her shoulder.

The Cornell University ergonomics website provides some tips with respect to using a computer mouse in a manner which will avoid mouse-related musculoskeletal injury, and the problems which create such injury. That website points out that there are exposed blood vessels near the skin at the wrist, where the pulse is often taken, and that any pressure in this region will disrupt circulation into the hand, increasing the risk of injury. It also points out that using a wrist rest doubles the pressure inside the carpal tunnel, because the floor of the tunnel is a more flexible ligament that transmits external pressure changes directly into the carpal tunnel. Since the roof of the tunnel is bone, the pressure does not get transmitted on through the hand. A softly padded wrist rest, this website advises, especially one that is rounded, causes the forearm to become “locked” into position, encouraging people to make mouse movements by flicking the wrist, and action which also increases intracarpal pressure. It is pointed out that the base of the palm of the hand is the part of the body designed to support the hand when resting on a surface.

In order to reduce and minimize RMI for computer users, a palm support is often placed in front of the keyboard to provide support for the palm of the hand during brief pauses from keying. Such a palm support provides a rounded upper surface.

A good technical description of the problems confronting users of computer mice is set out in U.S. Pat. No. 5,414,445 of Kaneko et al., issued May 9, 1995. This patent is directed to an ergonomically designed mouse which assists in keeping the user's arm, wrist and hand within a biomechanically neutral zone achieved when the flexors and extensors of the user's hand and wrists are in equilibrium, and static loads on the forearm muscles and other large muscle groups are minimized.

Hand and wrist supports for computer mice have been developed with a view to reducing RMI and preventing CTS, such as those described and illustrated in Martin et al. U.S. Pat. No. 5,340,067 issued Aug. 23, 1994 and Tajiri U.S. Pat. No. 5,581,277 issued Dec. 3, 1996 which illustrate working surface supported hand supports. A wrap around support block is described and illustrated by Martin et al., and a spherical attachment by Tajiri, in both cases to receive the palm of a user's hand and thereby support the hand and wrist in an appropriate, biomechanically neutral position. U.S. Pat. No. 6,193,196 of Hesley issued Feb. 27, 2001, describes and illustrates a working surface supported hand support in the form of an inclined planar surface which is seated beside and in front of the mouse. Again, the support surface is in the palm region of the user's hand. The bottom surface of the support permits sliding of the support device in tandem with the mouse.

Kravtin et al. U.S. Pat. Nos. 6,157,370 issued Dec. 5, 2000 and 6,396,478 issued May 28, 2002 describe and illustrate an ergonomic extension to a computer mouse, for facilitating use of the mouse by a user with the user's arm, wrist and hand in an ergonomically appropriate position. The extension is fixed to the computer mouse by way of an arm and a mechanism is provided for locking the arm in a variety of positions relative to the mouse. The extension itself provides an upper surface that conforms to a human palm, and supports the user's wrist elevating the palm and wrist to a desired position with respect to the mouse during use.

Other patents of general background interest teaching hand and/or forearm supports, for mouse users include U.S. Pat. No. 5,203,845 of Moore issued Apr. 20, 1993, U.S. Pat. No. 5,944,289 of Speece issued Aug. 31, 1999, U.S. Pat. No. 5,833,180 of Baranowski issued Nov. 10, 1998 and U.S. Pat. No. 6,585,198 of Dillon issued Jul. 1, 2003.

Many of these prior art devices provide support for the user's hand through the palm (i.e. that part of the hand extending from the heel of the hand to the base of the fingers). Others provide support for the forearm and palm. These constructions often restrict the relative movement of the user's hand and wrist and often provide cumbersome solutions to the problem of RMI and CTS.

U.S. Pat. No. 6,616,108 of Brophy et al. issued Sep. 9, 2003 describes and illustrates a deformable support for cushioning a mouse user's hand and wrist. The support is releasably coupled to the mouse by arms which extend forwardly from the cushioning surface. The cushioning material may be a resilient gel or foam, or may be a non-resilient, “firm” material such as sand, metal filings, grains, beans, clay or the like. In providing a cushioned rest area for the user's hand/wrist, the hand/wrist angle may be somewhat reduced but pressure is still applied to the carpal tunnel area. When pressure is applied to this area, the nerves that run through the carpal tunnel passageway will become pressed or squeezed. As well, broad pressure in the palm region adjoining the wrist, caused by this device, will disrupt blood flow into the hand. Over long term usage, chronic discomfort may result. Also, with the increased contact area of the hand/wrist support cushion in the Brophy et al. device, wear and irritation of the skin may result in this area. Moreover, Brophy et al. does not teach adjustability of the support surface area to different sizes of users' hands, no doubt because of the large, cushioning area designed to support a large portion of the user's hand. Also, because of the “give” from the cushion, the wrist may tend to sag with respect to the hand, providing a misalignment between the user's hand and wrist.

In applicant's co-pending U.S. application Ser. Nos. 10/845,090 and 11/183,883, devices are provided to be cooperatively associated with a computer mouse, the devices comprising support surfaces to be positioned both longitudinally and height-wise with respect to the mouse so as to support a central area of the heel of the user's hand so that the user's hand and wrist are in an ergonomically correct position relative to each other during use of the mouse.

### SUMMARY OF THE INVENTION

In accordance with a broad aspect of the present invention, there is provided a device to be associated with a computer mouse. The device comprises a body which, when the device is in use, circumscribes and moves with the mouse when the mouse moves on a surface. The body is provided with a support surface. The support surface is configured and adjustably positionable longitudinally so that when the device is in position with respect to the mouse, the support surface supports only a central portion of a heel of a user's hand at a height so that the user's hand and wrist are in an ergonomically correct, aligned position relative to each other during use of the mouse.

In a more particular aspect of the present invention, the device comprises a rear portion and a front portion. The rear portion comprises a base on which is secured, for longitudinal movement, the support surface. The front portion comprises a pair of arms fixed to and forwardly extending from the rear portion in a U-shaped configuration, and a cooperating inverted U-shaped stirrup relatively longitudinally moveable with respect to the arms. The stirrup and arms are configured so as to cradle the mouse. Means are associated with the stirrup and arms so as to move the stirrup and arms relatively together and hold the mouse, the device then to circumscribe and move with the mouse when the mouse moves on a surface.

In one embodiment of the present invention there is provided a thin, lower ledge on inner portions of the arms and stirrup, on which ledge the mouse operatively sits and is supported by the device when attached to the mouse.

The device of the present invention is simple to construct and yet is extremely effective in supporting a user's hand, wrist (and arm) in an ergonomically correct position when using the computer mouse.

### BRIEF DESCRIPTION OF THE DRAWINGS

These and other advantages of the invention will become apparent upon reading the following detailed description and upon referring to the drawings in which:

FIG. 1 is a perspective view of one embodiment of support device according to the present invention;

FIG. 2 is a plan view from above of an alternative embodiment of the device of FIG. 1;

FIG. 3 is a view of the front of a hand illustrating the effective area of a person's hand to which the support device of the present invention is directed.

FIGS. 4A and 4B are respectively a plan view from above and a side view of the device of FIG. 1 illustrating (in phantom a mouse and a user's hand in position on the device and mouse);

FIG. 5 is a partial, perspective view of the device of FIG. 1, with components illustrated in exploded form;

FIG. 6 is a plan view from above of an alternative embodiment of support device according to the present invention; and

FIG. 7 is a plan view, from above, of the device of FIG. 5 with an upper part of the rear portion removed, to better illustrate the workings of this embodiment.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given similar reference numerals.

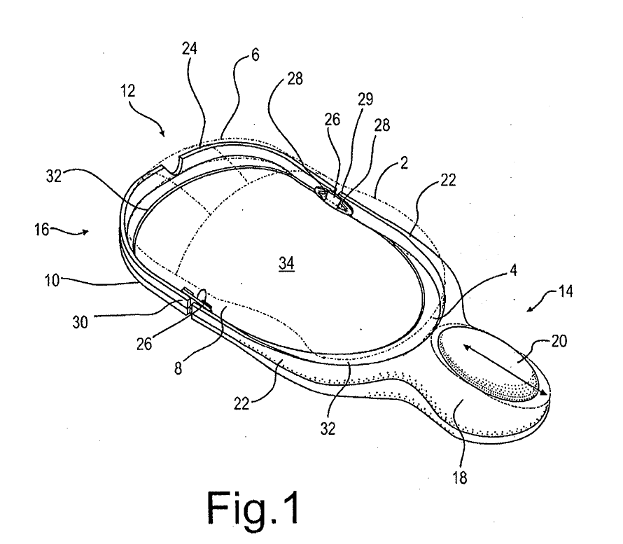

Turning to FIG. 1 there is illustrated, associated with a conventional computer mouse 2, which mouse has a rear 4, front 6, sides 8 and base 10, a device 12 designed to circumscribe the rear, front and sides of mouse 2 and be secured thereto in a manner as will be described in more detail hereinafter. Device 12 comprises a rear portion 14 and front portion 16. Rear portion 16 comprises a base 18 on which is secured, for longitudinal movement, towards the front and rear, a convexly shaped support surface 20. Arms 22 are fixed to and forwardly extend from rear portion 14 in “U-”shape configuration, as can be seen in FIG. 1. Arms 22 co-operate with an inverted U-shaped stirrup 24 which is relatively longitudinally moveable with respect to those arms. The arms 22 and stirrup 24 are configured so as to circumscribe and cradle within, mouse 2.

Means are provided, which in the embodiment of FIG. 1 comprise a pair of rubber or otherwise elasticized bands 26, secured to hooks 28 at the external ends 29 of arms 22 and corresponding ends 30 of sides of stirrup 24, bands 26 stretching to permit the stirrup 24 to be moved longitudinally away from arms 22 and rear portion 14, so that mouse 2 can be either placed into or removed from device 12. Then stirrup 24 is allowed to be retracted towards arm 22 so that the mouse 2 is secured in position with respect to device 12.

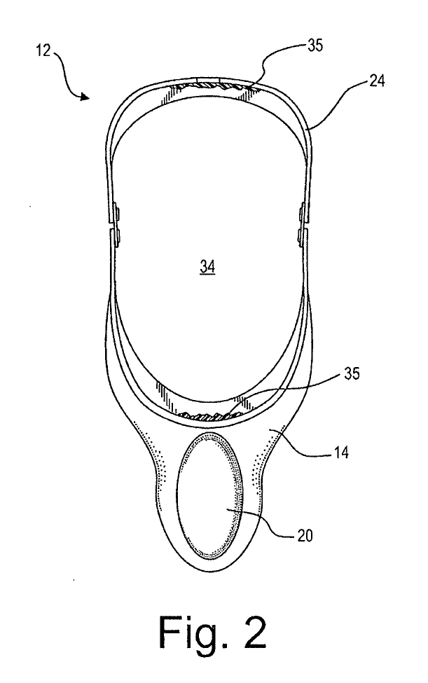

A thin rim portion 32 is provided, as illustrated in FIGS. 1 and 2, along lower portions of inner sides of stirrup 24 and arms 22, to supportably receive mouse 2 when in position in device 12. An opening 34 is provided, within cradle 24, arms 22 and rim portions 32, of sufficient size so as not to interfere with the operation of mouse 2, when in use.

In FIG. 2, there is illustrated a plan view from above of a device 12 according to the present invention, which is similar to that of FIG. 1 with the exception that resilient friction means 35, such as strips of rubber, are secured, as illustrated, to inner portions of rear portion 14 and stirrup 24, to further assist in securing a computer mouse 2 within device 12, during use.

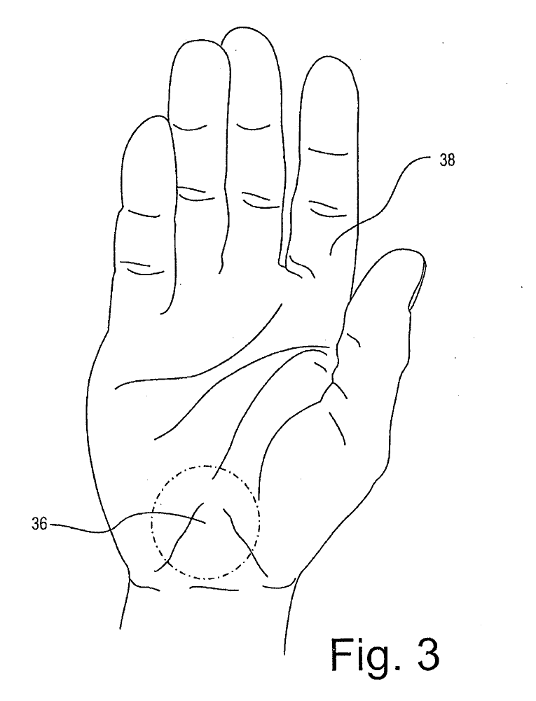

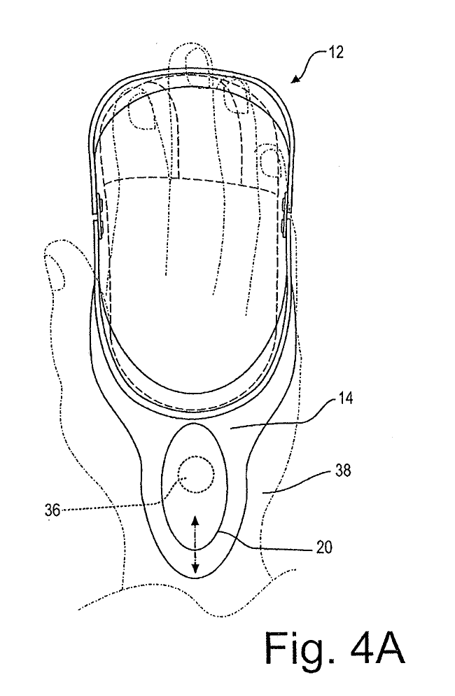

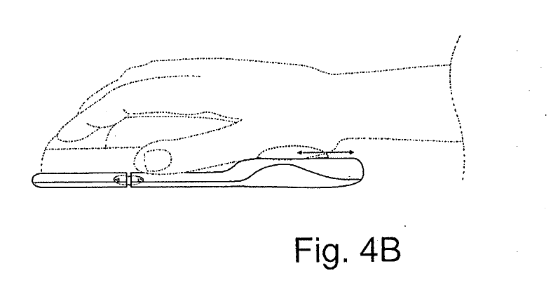

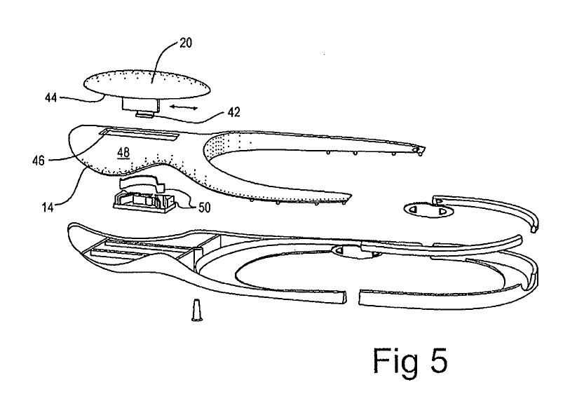

The purpose of support surface 20 on device 12 is to sit in the central area 36 (FIG. 3) of the heel of the user's hand 38 as can be seen in FIG. 4A, and to be at an appropriate height (FIG. 4B) with respect to the upper surface 40 of mouse 2 so as to provide proper ergonomic positioning of the user's hand, wrist and forearm when using mouse 2 (as illustrated in FIG. 4B). To ensure that support surface 20 rests under central area 36 of the user's hand 38, because different users may have different sized hands, support surface 20 is associated with rear portion 14 so as to be longitudinally moveable. This is accomplished in any conventional manner, but in the illustrated embodiment is accomplished by means of a post 42 which extends downwardly from a lower portion 44 of support surface 20 through a slot 46 passing through the upper surface 48 of rear portion 14. A lower portion of post 42 is secured within a mechanism 50 which permits forward and rearward movement of the post (and hence support surface 20) and the releasable securing of the post 42 (and support surface 20) in a particular, desired location. Mechanism 50 is of conventional construction, and is held within a chamber within rear portion 14.

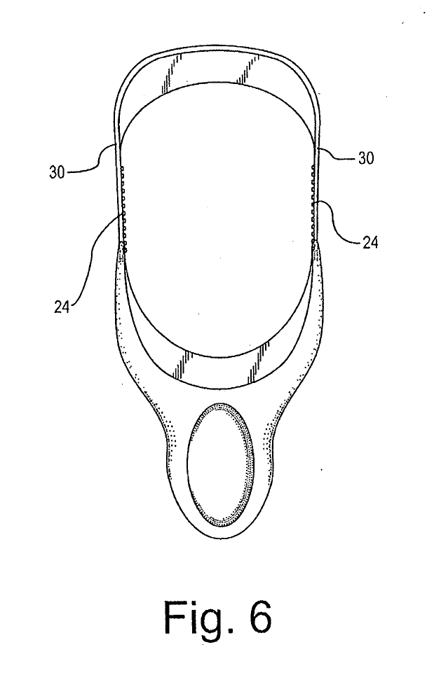

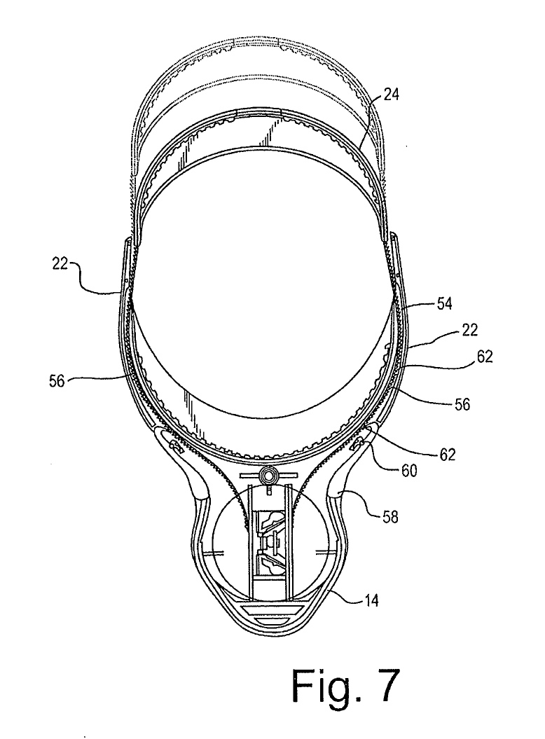

A device 12 in accordance with the present invention having many similar features to those of the devices illustrated in FIGS. 1 and 2 is illustrated in FIG. 6. However, instead of elastic bands 26 and hooks 28 providing the relative movement and positioning of stirrup 24 with respect to arms 22, for securing mouse 2 in position within device 12, an alternative arrangement in the form of bands 54 extending from ends 30 of stirrup 24 is provided. These bands are adjustably positionable, and securable in a particular position, within channels 56 formed in arms 22 as illustrated. A conventional ratchet-type flipper handle 58 pivotable about pivot 60 is provided, with an engagement hook 62, associated with each band 54, and used to tighten, or as may be the case, loosen bands 54 in buckles 56 by acting on co-operating stepped surfaces 62 of bands 54 as illustrated, when handle 58 is pushed inwardly, to loosen, or repetitively moved outwardly, to tighten.

Thus, it is apparent that there has been provided in accordance with the invention a hand positioner for a computer mouse that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What I claim as my invention:

1. A device to be associated with a computer mouse, the device comprising a body which, when the device is in use, circumscribes and moves with the mouse when the mouse moves on a surface, the body provided with a support surface, the support surface being configured and adjustably positionable longitudinally so that when the device is in position with respect to the mouse, the support surface supports only a central portion of a heel of a user's hand at a height so that the user's hand and wrist are in an ergonomically correct, aligned position relative to each other during use of the mouse.

2. A device according to claim 1, the device comprising a rear portion and a front portion, the rear portion comprising a base on which is secured, for longitudinal movement, the support surface, the rear portion comprising a pair of arms fixed to and forwardly extending from the rear portion in a U-shaped configuration, and a cooperating inverted U-shaped stirrup relatively longitudinally moveable with respect to the arms, the stirrup and arms being configured, when in use, so as to cradle the mouse, means associated with the stirrup and arms so as to move the stirrup and arms relatively together and grip the mouse to secure it to the device in attached position, then to circumscribe and move with the mouse when the mouse moves on a surface.

3. A device according to claim 2, wherein a thin, lower ledge is provided on inner portions of the arms and stirrup, on which ledge the mouse operatively sits and is supported by the device when attached to the mouse.

4. A device according to claim 2, wherein the arms and stirrup are resiliently attached to each other so as to permit relative longitudinal movement of the stirrup with respect to the arms enabling the device to expand longitudinally when being attached to the mouse.

5. A device according to claim 4, wherein hooks are provided on the arms and stirrup, to which hooks elastic bands are attached, the elastic bands providing the resilient attachment of the stirrup to the arms.

6. A device according to claim 3, wherein the arms and stirrup are resiliently attached to each other so as to permit relative longitudinal movement of the stirrup with respect to the arms enabling the device to expand longitudinally when being attached to the mouse.

7. A device according to claim 6, wherein hooks are provided on the arms and stirrup, to which hooks elastic bands are attached, the elastic bands providing the resilient attachment of the stirrup to the arms.

8. A device according to claim 2, wherein the stirrup is secured to the arms by means of straps extending from sides of the stirrups, the straps being adjustably seated in channels associated with the rear portion of the device by way of ratchet type flipper handles pivotably secured to the rear portion of the device and acting on stepped surfaces of the straps.

9. A device according to claim 3, wherein the stirrup is secured to the arms by means of straps extending from sides of the stirrups, the straps being adjustably seated in channels associated with the rear portion of the device by way of ratchet type flipper handles pivotably secured to the rear portion of the device and acting on stepped surfaces of the straps.

10. A device according to claim 2, wherein the support surface is seated for slidable, longitudinal movement on the base, a post downwardly extending from a lower surface of the support surface through a slot in the base, the post secured in a mechanism held in a chamber within the rear portion for longitudinal movement relative to the rear portion, the mechanism configured so as to releasably secure the support surface in one of a plurality of predetermined longitudinal locations against unintended movement out of that location.
